(19) United States
(12) Patent Application Publication
(10) Pub. No.: US 2021/0163768 A1
(43) Pub. Date: Jun. 3, 2021

(54) INKJET INK

(71) Applicant: KYOCERA Document Solutions Inc., Osaka (JP)

(72) Inventor: Akinori KOYAMA, Osaka-shi (JP)

(73) Assignee: KYOCERA Document Solutions Inc., Osaka (JP)

(21) Appl. No.: 17/102,676

(22) Filed: Nov. 24, 2020

(30) Foreign Application Priority Data
Nov. 28, 2019 (JP) 2019-215555

(51) Int. Cl. C09D 11/107; C09D 11/326; C09D 11/322; C09D 11/12; C09D 11/037

(52) U.S. Cl. CPC C09D 11/107; C09D 11/326; C09D 11/322; C08K 3/04; C09D 11/037; C08K 2201/011; C08K 2201/003; C09D 11/12

(57) ABSTRACT

An inkjet ink contains pigment particles containing a pigment, binder resin particles containing a binder resin, and wax particles containing a wax. A ratio (D_{W}/D_{B}) of a volume median diameter D_{W} of the wax particles to a volume median diameter D_{B} of the binder resin particles is at least 1.45. A ratio (D_{W}/D_{P}) of the volume median diameter D_{W} of the wax particles to a volume median diameter D_{P} of the pigment particles is at least 1.45. The volume median diameter D_{W} of the wax particles is no greater than 400 nm. An absolute value of a difference ΔAV between an acid value AV_{B} of the binder resin particles and an acid value AV_{W} of the wax particles is no greater than 11 mgKOH/g.

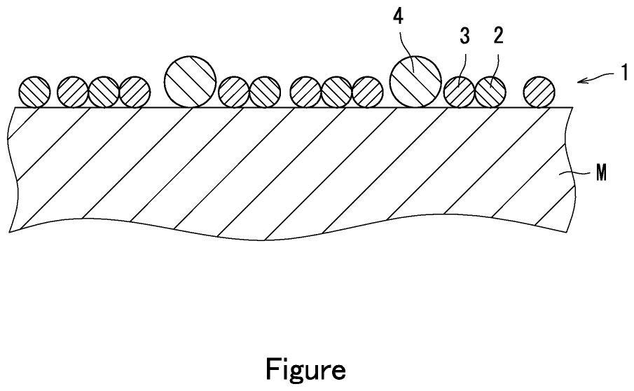

### INCORPORATION BY REFERENCE

The present application claims priority under 35 U.S.C. § 119 to Japanese Patent Application No. 2019-215555, filed on Nov. 28, 2019. The contents of this application are incorporated herein by reference in their entirety.

### BACKGROUND

The present disclosure relates to an inkjet ink.

There is a demand for an inkjet ink that is excellent in ejection stability and that enables formation of images excellent in scratch resistance. In order to accommodate such a demand, an inkjet ink is studied that contains for example pigment particles and either or both binder resin particles and wax particles.

### SUMMARY

An inkjet ink according to an aspect of the present disclosure contains pigment particles containing a pigment, binder resin particles containing a binder resin, and wax particles containing a wax. A ratio (D_{W}/D_{B}) of a volume median diameter D_{W} of the wax particles to a volume median diameter D_{B} of the binder resin particles is at least 1.45. A ratio (D_{W}/D_{P}) of the volume median diameter D_{W} of the wax particles to a volume median diameter D_{P} of the pigment particles is at least 1.45. The volume median diameter D_{W} of the wax particles is no greater than 400 nm. An absolute value of a difference ΔAV between an acid value AV_{B} of the binder resin particles and an acid value AV_{W} of the wax particles is no greater than 11 mgKOH/g.

### BRIEF DESCRIPTION OF THE DRAWINGS

FIGURE is a cross-sectional view explaining an image formed with an ink according to the present disclosure.

### DETAILED DESCRIPTION

An embodiment of the present disclosure will be described below. In the following, measurement values for volume median diameter (D₅₀) are values as measured using a dynamic light scattering type particle size distribution analyzer (“ZETASIZER NANO ZS”, product of Malvern Panalytical) unless otherwise stated.

The following describes an example of a method for measuring each of a volume median diameter D_{P} of pigment particles, a volume median diameter D_{B} of binder resin particles, and a volume median diameter D_{W} of wax particles in an inkjet ink. First, the inkjet ink is subjected to centrifugation to separate the pigment particles, the binder resin particles, and wax particles. Next, measurement using the aforementioned dynamic light scattering type particle size distribution analyzer is performed on the pigment particles, the binder resin particles, and the wax particles separated from one another. Through the above, each of the volume median diameter D_{P} of the pigment particles, the volume median diameter D_{B} of the binder resin particles, and the volume median diameter D_{W} of the wax particles can be measured.

Measurement values for acid value are values as measured using an automatic titrator (for example, “COM-1750”, product of HIRANUMA SANGYO Co., Ltd.) at a temperature of 25° C. unless otherwise stated.

Measurement values for melting point (Mp) is a temperature at a maximum heat absorption peak on a heat absorption curve (vertical axis: heat flow (DSC signal), horizontal axis: temperature) plotted using a differential scanning calorimeter (“DSC-6220”, product of Seiko Instruments Inc.) unless otherwise stated. The heat absorption peak appears due to crystallized portion melting.

In the present specification, the term “(meth)acryl” may be used as a generic term for both acryl and methacryl.

### <Ink>

The following describes an inkjet ink (also referred to below simply as an ink) of the present disclosure. The ink of the present disclosure contains pigment particles containing a pigment, binder resin particles containing a binder resin, and wax particles containing a wax. A ratio (D_{W}/D_{B}) of a volume median diameter D_{W} of the wax particles to a volume median diameter D_{B} of the binder resin particles is at least 1.45. A ratio (D_{W}/D_{P}) of the volume median diameter D_{W} of the wax particles to a volume median diameter D_{P} of the pigment particles is at least 1.45. The volume median diameter D_{W} of the wax particles is no greater than 400 nm. An absolute value of a difference ΔAV between an acid value AV_{B} of the binder resin particles and an acid value AV_{W} of the wax particles is no greater than 11 mgKOH/g.

As a result of having the above features, the ink of the present disclosure can exhibit excellent ejection stability and images excellent in scratch resistance can be formed with use of the ink of the present disclosure. The reasons therefor are presumed as follows. First, an image formed with the ink of the present disclosure contains the binder resin particles containing a binder resin and the wax particles containing a wax. The binder resin particles prompt fixation of the pigment particles to a recording medium. The wax particles increase slipperiness of the image formed with the ink of the present disclosure. The image formed with the ink of the present disclosure accordingly exhibits excellent scratch resistance.

Second, the ratio (D_{W}/D_{B}) of the volume median diameter D_{W} of the wax particles to the volume median diameter D_{B} of the binder resin particles is at least 1.45 in the ink of the present disclosure. Furthermore, the ratio (D_{W}/D_{P}) of the volume median diameter D_{W} of the wax particles to the volume median diameter D_{P} of the pigment particles is at least 1.45 in the ink of the present disclosure. That is, the wax particles are relatively larger in particle diameter than the pigment particles and the binder resin particles. The wax particles, which have a relatively large particle diameter, function as spacers in an image formed with the ink of the present disclosure. An image formed with the ink of the present disclosure will be described below with reference to FIGURE. FIGURE is a cross-sectional view explaining an image 1 formed on a recording medium M with the ink of the present disclosure. The image 1 is constituted by pigment particles 2, binder resin particles 3, and wax particles 4. The wax particles 4 have a relatively large particle diameter. Accordingly, when the image 1 comes in contact with a different member (for example, a recording medium different from the recording medium M), the wax particles 4 prevent the pigment particles 2 and the binder resin particles 3 from coming into contact with the above-described different member. That is, the wax particles 4 function as spacers. Even when the image 1 comes in contact with the different member, the pigment particles 2 and the binder resin particles 3 are hardly detached from the recording medium M owing to the wax particles 4 functioning as spacers. An image formed with the ink of the present disclosure has been described so far with reference to FIGURE. As a result of the wax particles 4 functioning as spacers, the image formed with the ink of the present disclosure exhibits excellent scratch resistance.

Third, the volume median diameter D_{W} of the wax particles of the ink of the present disclosure is no greater than 400 nm. This inhibits occurrence of nozzle clogging with the wax particles of the ink of the present disclosure, thereby presenting excellent ejection stability of the ink. Furthermore, the absolute value of the difference ΔAV between the acid value AV_{B} of the binder resin particles and an acid value AV_{W} of the wax particles is no greater than 11 mgKOH/g. Here, an ink containing binder resin particles and wax particles between which an absolute value of a difference ΔAV is excessively large tends to have low affinity between the binder resin particles and the wax particles. Accordingly, when an image is formed on a recording medium with the ink containing binder resin particles and wax particles between which an absolute value of a difference ΔAV is excessively large, a phenomenon readily occurs in which the wax particles agglomerate in the process of the ink drying on the recording medium. When the above phenomenon occurs, the wax particles disperse non-uniformly on the formed image and hardly fulfill the function as spacers accordingly. By contrast, the ink of the present disclosure contains the binder resin particles and the wax particles between which an absolute value of a difference ΔAV is no greater than 11 mgKOH/g. Therefore, the wax particles disperse uniformly on an image formed with the ink of the present disclosure to readily fulfil the function as spacers. For the above reasons, the ink of the present disclosure can exhibit excellent ejection stability and images excellent in scratch resistance can be formed with use of the ink of the present disclosure.

The following describes the ink of the present disclosure further in detail. Note that one of components described below may be used independently or two or more of the components may be used in combination.

### [Pigment Particles]

The pigment particles contain a pigment. The pigment particles have a volume median diameter D_{P} of preferably at least 50 nm and no greater than 150 nm, and more preferably at least 70 nm and no greater than 120 nm. As a result of the volume median diameter D_{P} of the pigment particles being set to at least 50 nm, agglomeration of the pigment particles can be inhibited. As a result of the volume median diameter D_{P} of the pigment particles being set to no greater than 150 nm, excessive increase in volume median diameter D_{W} of the wax particles can be suppressed even while the ratio (D_{W}/D_{P}) can be increased to 1.45 or more.

The pigment particles may only contain a pigment. Alternatively, the pigment particles may contain a pigment and a resin. Examples of pigment particles containing a pigment and a resin include pigment particles each including a pigment core containing a pigment and a resin covering a surface of the pigment core (also referred to below as a coating resin). A percentage content of the pigment in the pigment particles is preferably at least 80% by mass, more preferably at least 95% by mass, and further preferably 100% by mass.

Examples of the pigment include yellow pigments, orange pigments, red pigments, blue pigments, violet pigments, and black pigments. Examples of the yellow pigments include C. I. Pigment Yellow (74, 93, 95, 109, 110, 120, 128, 138, 139, 151, 154, 155, 173, 180, 185, or 193). Examples of the orange pigments include C. I. Pigment Orange (34, 36, 43, 61, 63, or 71). Examples of the red pigments include C.I. Pigment Red (122 or 202). Examples of the blue pigments include C. I. Pigment Blue (15, more specifically, 15:3). Examples of the violet pigments include C.I. Pigment Violet (19, 23, or 33). Examples of the black pigments include C. I. Pigment Black (7).

The percentage content of the pigment particles in the ink of the present disclosure is preferably at least 1.0% by mass and no greater than 15.0% by mass, and more preferably at least 4.0% by mass and no greater than 8.0% by mass. As a result of the percentage content of the pigment particles being set to at least 1.0% by mass, image density of formed images can be increased. As a result of the percentage content of the pigment particles being set to no greater than 15.0% by mass, fluidity of the ink of the present disclosure can be increased.

### [Binder Resin Particles]

The binder resin particles contain a binder resin. Preferably, the binder resin particles only contain a binder resin. A percentage content of the binder resin in the binder resin particles is preferably at least 80% by mass, more preferably at least 95% by mass, and further preferably 100% by mass.

The binder resin particles have a volume median diameter D_{B} of preferably at least 50 nm and no greater than 150 nm, and more preferably at least 70 nm and no greater than 120 nm. As a result of the volume median diameter D_{B} of the binder resin being set to at least 50 nm, agglomeration of the binder resin particles can be inhibited. As a result of the volume median diameter D_{B} of the binder resin particles being set to no greater than 150 nm, excessive increase in volume median diameter D_{W} of the wax particles can be suppressed even while the ratio (D_{W}/D_{P}) can be increased to 1.45 or more.

The binder resin particles preferably have an acid value AV_{B} of at least 9 mgKOH/g and no greater than 31 mgKOH/g. As a result of the acid value AV_{B} of the binder resin acid value being set to at least 9 mgKOH/g and no greater than 3 1 mgKOH/g, adjustment of the absolute value of the difference ΔAV to no greater than 11 mgKOH/g can be facilitated. The acid value AV_{B} of the binder resin particles can be increased for example by introducing a repeating unit having an acid group (for example, a repeating unit derived from (meth)acrylate or maleic acid) into the binder resin contained in the binder resin particles.

Examples of the binder resin include urethane resins, (meth)acrylic resins, styrene-(meth)acrylic resins, styrene-maleic acid copolymers, vinylnaphthalene-(meth)acrylic acid copolymers, and vinylnaphthalene-maleic acid copolymers. Here, a (meth)acrylic resin is a polymer including a repeating unit derived from (meth)acrylic acid or a (meth)acrylic acid alkyl ester. A styrene-(meth)acrylic resin is a polymer including a styrene unit and a repeating unit derived from (meth)acrylic acid or a (meth)acrylic acid alkyl ester.

Examples of the (meth)acrylic acid alkyl ester include methyl (meth)acrylate, ethyl (meth)acrylate, propyl (meth)acrylate, butyl (meth)acrylate, pentyl (meth)acrylate, hexyl (meth)acrylate, heptyl (meth)acrylate, and octyl (meth)acrylate.

The binder resin is preferably a (meth)acrylic resin, more preferably a polymer including a repeating unit derived from (meth)acrylic acid, a repeating unit derived from methyl (meth)acrylate, and a repeating unit derive from butyl (meth)acrylate (also referred to below as a specific (meth)acrylic resin), and further preferably a polymer including a repeating unit derived from methacrylic acid, a repeating unit derived from methyl methacrylate, and a repeating unit derived from butyl acrylate.

A percentage content of the repeating unit derived from (meth)acrylic acid in the specific (meth)acrylic resin is preferably at least 0.5% by mass and no greater than 10.5% by mass, and more preferably at least 2.0% by mass and no greater than 5.0% by mass. As a result of the percentage content of the repeating unit derived from (meth)acrylic acid being set to at least 0.5% by mass and no greater than 10.5% by mass, the specific (meth)acrylic resin can have an appropriate acid value.

Preferably, a ratio (R_{B}/R_{M}) of a percentage content R_{B} of the repeating unit derived from butyl (meth)acrylate to a percentage content R_{M} of the repeating unit derived from methyl (meth)acrylate in the specific (meth)acrylic resin is at least 20/80 and no greater than 40/60.

A percentage content of the binder resin particles in the ink of the present disclosure is preferably at least 0.5% by mass and no greater than 10.0% by mass, and more preferably at least 2.0% by mass and no greater than 4.0% by mass. As a result of the percentage content of the binder resin particles being set to at least 0.5% by mass, scratch resistance of images formed with the ink of the present disclosure can be increased. As a result of the percentage content of the binder resin particles being set to no greater than 10.0% by mass, ejection stability of the ink of the present disclosure can be further increased.

### [Wax Particles]

The wax particles contain a wax. Preferably, the wax particles only contain a wax. A percentage content of the wax in the wax particles is preferably at least 80% by mass, more preferably at least 95% by mass, and further preferably 100% by mass.

The wax particles have a volume median diameter D_{W} of no greater than 400 nm, preferably at least 100 nm and no greater than 400 nm, more preferably at least 130 nm and no greater than 200 nm, and further preferably at least 145 nm and no greater than 160 nm. As a result of the volume median diameter D_{W} of the wax particles being set to at least 100 nm, the wax particles readily fulfil the function as spacers. As a result of the volume median diameter D_{W} of the wax particles being set to no greater than 400 nm, occurrence of nozzle clogging with the ink of the present disclosure can be inhibited.

A ratio (D_{W}/D_{P}) of the volume median diameter D_{W} of the wax particles to the volume median diameter D_{P} of the pigment particles is at least 1.45, preferably at least 1.45 and no greater than 8.00, further preferably at least 1.45 and no greater than 4.00, and particularly preferably at least 1.50 and no greater than 2.00. As a result of the ratio (D_{W}/D_{P}) being set to at least 1.45, scratch resistance of images formed with the ink of the present disclosure can be increased. As a result of the ratio (D_{W}/D_{P}) being set to no greater than 8.00, ejection stability of the ink of the present disclosure can be further increased.

A ratio (D_{W}/D_{B}) of the volume median diameter D_{W} of the wax particles to the volume median diameter D_{B} of the binder resin particles is at least 1.45, preferably at least 1.45 and no greater than 8.00, further preferably at least 1.45 and no greater than 4.00, and particularly preferably at least 1.50 and no greater than 2.00. As a result of the ratio (D_{W}/D_{B}) being set to at least 1.45, scratch resistance of images formed with the ink of the present disclosure can be increased. As a result of the ratio (D_{W}/D_{B}) being set to no greater than 8.00, ejection stability of the ink of the present disclosure can be further increased.

The wax particles preferably have an acid value AV_{W} of at least 15 mgKOH/g and no greater than 25 mgKOH/g. As a result of the acid value AV_{W} of the wax particles being set to at least 15 mgKOH/g and no greater than 25 mgKOH/g, adjustment of the absolute value of the difference ΔAV to no greater than 11 mgKOH/g can be facilitated.

The absolute value of the difference ΔAV between the acid value AV_{B} of the binder resin particles and the acid value AV_{W} of the wax particles is no greater than 11 mgKOH/g, and preferably at least 5 mgKOH/g and no greater than 11 mgKOH/g. Note that the acid value AV_{W} of the wax particles may be higher or lower than the acid value AV_{B} of the binder resin particles.

Examples of the wax contained in the wax particles include aliphatic hydrocarbon waxes, oxides of aliphatic hydrocarbon waxes, plant waxes, animal waxes, mineral waxes, waxes having a fatty acid ester as a main component, and waxes in which a fatty acid ester has been partially or fully deoxidized.

Examples of the aliphatic hydrocarbon waxes include polyolefin waxes (for example, low molecular weight polyethylene, low molecular weight polypropylene, and polyolefin copolymers), microcrystalline wax, paraffin wax, and Fischer-Tropsch wax.

Examples of the oxides of aliphatic hydrocarbon waxes include polyethylene oxide wax and block copolymers of polyethylene oxide wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum.

Examples of the waxes having a fatty acid ester as a main component include montanic acid ester wax and castor wax. Examples of the waxes in which a fatty acid ester has been partially or fully deoxidized include deoxidized carnauba wax.

The wax contained in the wax particles is preferably a wax in which a fatty acid ester has been partially or fully deoxidized, an aliphatic hydrocarbon wax, or an oxide of an aliphatic hydrocarbon wax, and more preferably carnauba wax or polyethylene oxide wax.

A percentage content of the wax particles in the ink of the present disclosure is preferably at least 0.1% by mass and no greater than 3.0% by mass, and more preferably at least 0.5% by mass and no greater than 1.5% by mass. As a result of the percentage content of the wax particles being set to at least 0.1% by mass, scratch resistance of images formed with the ink of the present disclosure can be further increased. As a result of the percentage content of the wax particles being set to no greater than 3.0% by mass, ejection stability of the ink of the present disclosure can be further increased.

### [Water]

Where the ink of the present disclosure contains water, a percentage content of the water in the ink of the present disclosure is preferably at least 50.0% by mass and no greater than 90.0% by mass, and more preferably at least 60.0% by mass and no greater than 80.0% by mass.

### [Moisturizing Agent]

Preferably, the ink of the present disclosure contains a moisturizing agent. The moisturizing agent inhibits volatilization of a liquid component from the ink of the present disclosure. Examples of the moisturizing agent include polyalkylene glycol compounds, alkylene glycol compounds, and glycerin.

Examples of the polyalkylene glycol compounds include polyethylene glycol and polypropylene glycol.

Examples of the alkylene glycol compounds include 3-methyl-1,5-pentanediol, ethylene glycol, propylene glycol, butylene glycol, diethylene glycol, dipropylene glycol, trimethylene glycol (that is, 1,3-propanediol), triethylene glycol, tripropylene glycol, 1,2,6-hexanetriol, thiodiglycol, 1,3-butanediol, and 1,5-pentanediol.

The moisturizing agent is preferably an alkylene glycol compound or glycerin, and more preferably 3-methyl-1,5-pentanediol or glycerin.

A percentage content of the moisturizing agent in the ink of the present disclosure is preferably at least 3.0% by mass and no greater than 30.0% by mass, and more preferably at least 10.0% by mass and no greater than 20.0% by mass.

Where the ink of the present disclosure contains an alkylene glycol compound, a percentage content of the alkylene glycol compound in the ink of the present disclosure is preferably at least 2.0% by mass and no greater than 25.0% by mass, and more preferably at least 6.0% by mass and no greater than 15.0% by mass. Where the ink of the present disclosure contains glycerin, a percentage content of the glycerin in the ink of the present disclosure is preferably at least 0.5% by mass and no greater than 10.0% by mass, and more preferably at least 2.0% by mass and no greater than 7.0% by mass.

### [Penetrating Agent]

Preferably, the ink of the present disclosure contains a penetrating agent. The penetrating agent increases permeability of the ink of the present disclosure to a recording medium. Examples of the penetrating agent include diethylene glycol monobutyl ether and triethylene glycol monobutyl ether. Diethylene glycol monobutyl ether is preferable as the penetrating agent.

Where the ink of the present disclosure contains a penetrating agent, a percentage content of the penetrating agent in the ink of the present disclosure is preferably at least 0.5% by mass and no greater than 20.0% by mass, and more preferably at least 1.5% by mass and no greater than 5.0% by mass.

### [Surfactant]

Preferably, the ink of the present disclosure contains a surfactant. The surfactant increases wettability of the ink of the present disclosure to a recording medium. Examples of the surfactant include nonionic surfactants, anionic surfactants, and silicone surfactants. A nonionic surfactant is preferable as the surfactant. An acetylene glycol surfactant is preferable as the nonionic surfactant.

Where the ink of the present disclosure contains a surfactant, a percentage content of the surfactant in the ink of the present disclosure is preferably at least 0.1% by mass and no greater than 3.0% by mass, and more preferably at least 0.3% by mass and no greater than 1.0% by mass.

### [Other Components]

The ink of the present disclosure may further contain a known additive (specific examples include a solution stabilizer, an anti-drying agent, an antioxidant, a viscosity modifier, a pH adjuster, and an antifungal agent) as necessary.

### [Ink Production Method]

The ink of the present disclosure can be produced for example by uniformly mixing a pigment particle dispersion containing the pigment particles, a binder resin particle dispersion containing the binder resin particles, a wax particle dispersion containing the wax particles, and a component used as necessary (for example, any of water, a moisturizing agent, a penetrating agent, and a surfactant). In production of the ink of the present disclosure, foreign matter and coarse particles may be removed using a filter (for example, a filter having a pore size of no greater than 5 μm) after uniform mixing of the components.

### (Pigment Particle Dispersion)

The pigment particle dispersion is a dispersion containing the pigment particles. A preferable dispersion medium of the pigment particle dispersion is water. The pigment particle dispersion can be prepared by dispersing the pigment in water. A percentage content of the pigment particles in the pigment particle dispersion is for example at least 5.0% by mass and no greater than 25.0% by mass.

Where the pigment particle dispersion is used as a raw material of the ink of the present disclosure, a ratio of the pigment particle dispersion to all raw materials of the ink is for example at least 30.0% by mass and no greater than 50.0% by mass.

### (Binder Resin Particle Dispersion)

The binder resin particle dispersion is a dispersion containing the binder resin particles. A preferable dispersion medium of the binder resin particle dispersion is water. Preferably, the binder resin particle dispersion contains the emulsifier (for example, an anionic surfactant). The binder resin particle dispersion can be prepared for example by emulsion polymerization of a raw material monomer of the binder resin in presence of water and an emulsifier. A percentage content of the binder resin particles in the binder resin particle dispersion is for example at least 30.0% by mass and no greater than 50.0% by mass. A percentage content of the emulsifier in the binder resin particle dispersion is for example at least 0.3% by mass and no greater than 4.0% by mass.

Where the binder resin particle dispersion is used as a raw material of the ink of the present disclosure, a percentage content of the binder resin particle dispersion to all the raw materials of the ink is for example at least 3.0% by mass and no greater than 15.0% by mass.

### (Wax Particle Dispersion)

The wax particle dispersion is a dispersion containing the wax particles. A preferable dispersion medium of the wax particle dispersion is water. Preferably, the wax particle dispersion contains an emulsifier (for example, a nonionic surfactant) and a base (for example, potassium hydroxide). The wax particle dispersion can be prepared by high-speed stirring of the wax for example in presence of water, the emulsifier, and a base. The high-speed stirring may be performed under stirring conditions of a temperature of 120° C. or higher and 200° C. or lower and a pressure of 100 kg/cm² or higher and 600 kg/cm² or lower. A percentage content of the wax particles in the wax particle dispersion is for example at least 30.0% by mass and no greater than 50.0% by mass. A percentage content of the emulsifier in the wax particle dispersion is for example at least 2.0% by mass and no greater than 15.0% by mass. A percentage content of the base in the wax particle dispersion is for example at least 0.1% by mass and no greater than 3.0% by mass.

Where the wax particle dispersion is used as a raw material of the ink of the present disclosure, a percentage content of the wax particle dispersion to all the raw materials of the ink is for example at least 0.5% by mass and no greater than 10.0% by mass.

### EXAMPLES

The following describes examples of the present disclosure. However, the present disclosure is no way limited to the following examples.

In the present examples, a volume median diameter of each component (specifically, volume median diameter D_{B} of binder resin particles, volume median diameter D_{P} of pigment particles, and volume median diameter D_{W} of wax particles) were measured using a dynamic light scattering type particle size distribution analyzer (“ZETASIZER NANO ZS”, product of Malvern Panalytical) at a temperature of 25° C. In the measurement, each component was diluted with ion exchange water as necessary.

In the present examples, an acid value of each component (specifically, acid value AV_{B} of binder resin particles and acid value AV_{W} of wax particles) was measured by the following method at a temperature of 25° C. In the measurement, binder resin particle dispersions each containing binder resin particles and wax particle dispersions each containing wax particles were used each as measurement samples (solid concentration: 40% by mass). First, 100 g of the measurement sample was diluted with ion exchange water to prepare a dilution having a solid concentration of 5% by mass. Next, the dilution was titrated with 0.1 mol/L potassium hydroxide ethanol solution (titer: a) using an automatic titrator (“COM-1750”, product of HIRANUMA SANGYO Co., Ltd). An amount of the 0.1 mol/L potassium hydroxide ethanol solution required until a titration end point has been reached was represented by “b [mL]”. Next, ion exchange water was titrated with 0.1 mol/L aqueous potassium hydroxide solution using the aforementioned automatic titrator. An amount of the 0.1 mol/L aqueous potassium hydroxide solution required until a titration end point has been reached was represented by as “c [mL]”. Each acid value [mgKOH/g] of the measurement samples was calculated based on the following equation.

Acid value [mgKOH/g]=(5.611×(b−c)×a)/((X/100)×Y)

X [% by mass]: solid concentration of measurement sample (40% by mass in the present examples)

Y [g]: amount of measurement sample used (100 g in the present examples)

a: titer of 0.1 mol/L potassium hydroxide ethanol solution

b [mL]: amount of 0.1 mol/L potassium hydroxide ethanol solution required until a titration end point has been reached in titration of dilution

c [mL]: amount of 0.1 mol/L aqueous potassium hydroxide solution required until a titration end point has been reached in titration of ion exchange water

### (Preparation of Binder Resin Particle Dispersion A)

An emulsified monomer composition (151.4 parts by mass) was yielded by stirring 40.0 part by mass of ion exchange water, 8.0 parts by mass of an anionic surfactant (“EMULSOGEN (registered Japanese trademark) EPA073”, product of Clamant (Japan) K.K., solid content concentration 28% by mass), and a monomer mixture of 70.0 parts by mass of methyl methacrylate, 30.0 parts by mass of butyl acrylate, and 3.4 parts by mass of methacrylic acid.

Next, a reaction vessel equipped with a reflux cooling tube, a stirrer, a thermometer, a nitrogen inlet tube, and a dropping funnel was prepared. The reaction vessel was charged with 60.0 parts by mass of ion exchange water and 3.0 parts by mass of an anionic surfactant (EMULSOGEN (registered Japanese trademark) EPA073”, product of Clamant (Japan) K.K., solid concentration 28% by mass), and then, the temperature of the contents of the reaction vessel was increased to 80° C. The reaction vessel was then charged with 5.0% by mass (7.57 parts by mass) of the yielded emulsified monomer composition, and the vessel contents were stirred. Subsequently, initial polymerization reaction was induced by adding 1.5 parts by mass of 3.0% by mass aqueous potassium persulfate solution into the reaction vessel. Thereafter, 6.5 parts by mass of 3.0% by mass aqueous potassium persulfate solution and 95.0% by mass (143.83 parts by mass) of the rest of the above-described emulsified monomer composition were dripped into the reaction vessel over 5 hours while the temperature of the contents of the reaction vessel was kept at 80° C. Through the dripping, polymerization reaction was carried out. Thereafter, 10.0% by mass aqueous ammonia solution was added into the reaction vessel to adjust the pH of the vessel contents to 8.0. Ion exchange water was then added into the reaction vessel to adjust the solid concentration of the contents to 40.0% by mass. Through the above processes, a binder resin particle dispersion A containing binder resin particles (solid concentration 40.0% by mass) was obtained.

Binder resin particle dispersions B to E were prepared according to the same method as for preparation of the binder resin particle dispersion A in all aspects other than the following changes.

### (Preparation of Binder Resin Particle Dispersion B)

In the preparation of the binder resin particle dispersion B, the amount of methacrylic acid used in the monomer mixture was changed to 10.0 parts by mass.

### (Preparation of Binder Resin Particle Dispersion C)

In the preparation of the binder resin particle dispersion C, the amount of methacrylic acid used in the monomer mixture was changed to 2.6 parts by mass.

### (Preparation of Binder Resin Particle Dispersion D)

In the preparation of the binder resin particle dispersion D, the amount of methacrylic acid used in the monomer mixture was changed to 11.0 parts by mass.

### (Preparation of Binder Resin Particle Dispersion E)

In the preparation of the binder resin particle dispersion E, the amount of the anionic surfactant (EMULSOGEN (registered Japanese trademark) EPA073”, product of Clariant (Japan) K.K.) used was changed from 3.0 parts by mass to 10.0 parts by mass.

A volume median diameter D_{B} and an acid value AV_{B} of the binder resin particles contained in each of the binder resin particle dispersions A to E were measured. Measurement results were shown in Table 1 below. Table 1 shows components of the monomer mixture in preparation of each of the binder resin particle dispersion A to E in addition.

TABLE 1

| Binder resin particle dispersion | | A | B | C | D | E |
|---|---|---|---|---|---|---|
| Monomer | Methyl methacrylate | 70.0 | 70.0 | 70.0 | 70.0 | 70.0 |
| mixture | Butyl methacrylate | 30.0 | 30.0 | 30.0 | 30.0 | 30.0 |
| [part by | Methacrylic acid | 3.4 | 10.0 | 2.6 | 11.0 | 3.4 |
| mass] | Total | 103.4 | 110.0 | 102.6 | 111.0 | 103.4 |

| | | | | | |
|---|---|---|---|---|---|
| Volume median diameter D_{B} [nm] | 100 | 100 | 100 | 100 | 80 |
| Acid value AV_{B} [mgKOH/g] | 10 | 30 | 8 | 32 | 10 |

### (Preparation of Wax Particle Dispersion A)

A high-speed emulsifier/disperser (“HOMOGENIZING MIXER MARK II”, product of PRIMIX Corporation, for high-pressure, high-temperature emulsions, dispersions, and reactions) was charged with 200 parts by mass of a polyethylene oxide wax (“HI-WAX (registered Japanese trademark) 4502E”, product of Mitsui Chemicals, Inc., melting point: 115° C., acid value: 20 mgKOH/g), 450 parts by mass of ion exchange water, 40 parts by mass of a nonionic surfactant (“NAROACTY (registered Japanese trademark) CL-50”, product of Sanyo Chemical Industries, Ltd.), and 10 parts by mass of 48% by mass aqueous potassium hydroxide solution. After the inside of the high-speed emulsifier/disperser was purged with nitrogen, the contents of the high-speed emulsifier/disperser were subjected to high-speed stirring for one hour under conditions of a pressure of 350 kg/cm², a temperature of 150° C., and a rotational speed of 10,000 rpm, and then cooled. Through the above processes, a wax particle dispersion A (wax concentration 40% by mass) was obtained.

Wax particle dispersions B to F were prepared according to the same method as for preparation of the wax particle dispersion A in all aspects other than the following changes.

### (Preparation of Wax Particle Dispersions B to D and F)

In preparation of the wax particle dispersions B to D and F, the pressure in the high-speed stirring by the high-speed emulsifier/disperser was changed to those shown in Table 2 below.

### (Preparation of Wax Particle Dispersion E)

In preparation of the wax particle dispersion E, the same amount of a carnauba wax (product of TOA KASEI CO., LTD., melting point 82° C., acid value 12 mgKOH/g) as that of the polyethylene oxide wax was used instead of the polyethylene oxide wax. Furthermore, the temperature in the high-speed stirring by the high-speed emulsifier/disperser was changed to 130° C. in the preparation of the wax particle dispersion E.

A volume median diameter D_{W} and an acid value AV_{W} of the wax particles contained in each of the wax particle dispersions A to F were measured. Measurement results are shown together in Table 2. In Table 2, “OPE” and “CW” represent oxidized polyethylene wax and carnauba wax, respectively.

TABLE 2

| Wax particle dispersion | A | B | C | D | E | F |
|---|---|---|---|---|---|---|
| Type | OPE | OPE | OPE | OPE | CW | OPE |
| Pressure [kg/cm²] | 350 | 400 | 500 | 120 | 350 | 50 |
| Temperature [° C.] | 160 | 160 | 160 | 160 | 130 | 160 |
| Volume media diameter | 150 | 140 | 120 | 380 | 150 | 500 |
| D_{W} [nm] | | | | | | |
| Acid value AV_{W} [mgKOH/g] | 20 | 20 | 20 | 20 | 12 | 20 |

### (Preparation of Pigment Particle Dispersion A)

A mixture in a slurry state was obtained by mixing 10 parts by mass of carbon black (“CARBON BLACK #960”, product of Mitsubishi Chemical Corporation) as a pigment, 5 parts by mass of a dispersant (“DISPERBYK (registered Japanese trademark) 180”, product of BYK Japan KK), 5 parts by mass of glycerin, and 80 parts by mass of ion exchange water. The resultant mixture was subjected to dispersion treatment for 180 minutes using a nanoparticle disperser (“ULTRA APEX MILL (registered Japanese trademark) UAM-015”, product of HIROSHIMA METAL & MACHINERY CO., LTD.). In the dispersion treatment, zirconia beads having a number average primary particle diameter of 0.02 mm were used as a medium. Through the dispersion treatment, a pigment particle dispersion A containing carbon black was obtained. Pigment particles in the pigment particle dispersion A had a D₅₀ of 100 nm.

### (Preparation of Pigment Particle Dispersion B)

A pigment particle dispersion B was prepared according to the same method as for the pigment particle dispersion A in all aspects other than the following changes. In the preparation of the pigment particle dispersion B, the type of the pigment was changed to a cyan pigment (“PI-15:3”, product of Dainichiseika Color & Chemicals Mfg. Co., Ltd.) and the type of the dispersant was changed to “DISPERBYK (registered Japanese trademark) 184”, produced by BYK Japan KK. Furthermore, the time for the dispersion treatment in the preparation of the pigment particle dispersion B was changed to 150 minutes. Pigment particles in the pigment particle dispersion B had a D₅₀ of 90 nm.

### (Preparation of Pigment Particle Dispersion C)

A pigment particle dispersion C was prepared according to the same method as for the pigment particle dispersion A in all aspects other than the following changes. In the preparation of the pigment particle dispersion C, the type of the dispersant was changed to “DISPERBYK (registered Japanese trademark) 2010” produced by BYK Japan KK. Furthermore, the time for the dispersion treatment in the preparation of the pigment particle dispersion C was changed to 360 minutes. Pigment particles in the pigment particle dispersion C had a D₅₀ of 80 nm.

### <Ink Production>

### Example 1

All of 40.0 parts by mass of the pigment particle dispersion A, 4.0 parts by mass of glycerin (product of Kao Corporation) as a moisturizing agent, 10.0 parts by mass of 3-methyl-1,5-pentanediol (product of Kuraray Co., Ltd.) as a moisturizing agent, 3.0 parts by mass of diethylene glycol monobutyl ether (“BUCHISENOL (registered Japanese trademark) 20”, product of KH Neochem Co., Ltd.) as a penetrating agent, 0.5 parts by mass of an acetylene glycol surfactant (“SURFYNOL (registered Japanese trademark) 440”, product of Nissin Chemical Industry Co., Ltd), 32.5 parts by mass of ion exchange water, 7.5 parts by mass of the binder resin particle dispersion A, and 2.5 parts by mass of the wax particle dispersion A were mixed together. Through the mixing, an ink of Example 1 was obtained. An amount of each raw material and an effective amount of each component of the ink of Example 1 are shown in Table 3 below.

TABLE 3

| | | Amount | Effective amount |
|---|---|---|---|
| | | [% by mass] | [% by mass] |
| Pigment particle dispersion A | | 40.0 | 6.0 |
| Moisturizing | Glycerin | 4.0 | 4.0 |
| agent | 3-Methyl-1,5-pentanediol | 10.0 | 10.0 |
| Penetrating | Diethylene glycol | 3.0 | 3.0 |
| agent | monobutyl ether | | |
| surfactant | Acetylene glycol | 0.5 | 0.5 |
| | surfactant | | |

| | | |
|---|---|---|
| Ion exchange water | 32.5 | 72.5 |
| Binder resin particle dispersion A | 7.5 | 3.0 |
| Wax particle dispersion A | 2.5 | 1.0 |
| Total | 100.0 | 100.0 |

### Examples 2 to 6 and Comparative Examples 1 to 5

Inks of Examples 2 to 6 and Comparative Examples 1 to 5 were produced according to the same method as for the ink of Example 1 in all aspects other than the following changes. In the production of the inks of Examples 2 to 6 and Comparative Examples 1 to 5, the type of the pigment particle dispersion, the type of the binder resin particle dispersion, and the type of the wax particle dispersion were changed to those shown in Table 4 below.

### <Evaluation>

Ejection stability and scratch resistance of a formed image were evaluated for each of the inks of Examples 1 to 6 and Comparative Examples 1 to 5 by the following methods. In the evaluation, an inkjet printer including recording heads of piezoelectric inkjet type (prototype of KYOCERA Document Solutions Inc., nozzle length 30 μm, opening diameter 10 μm) was used as an evaluation apparatus. Measurement results are shown in Table 4.

### [Ejection Stability]

A solid image having a size of 4 cm by 5 cm (ink load: 0.5 mg/cm²) was formed on printing paper (“C² (registered Japanese trademark)”, product of Fuji Xerox Co., Ltd.) by ejecting the ink from all nozzles of the evaluation apparatus. After 3 minutes had elapsed from formation of the solid image, a solid image was formed again by the same method as for the solid image formed first. Then, the solid image formed second was observed to check the presence or absence of any image defects resulting from non-ejection from any nozzles. Ejection stability of each ink was evaluated as “Good (A)” if no image defect resulting from non-ejection from the nozzles had occurred, and evaluated as “Poor (B)” if such an image defect had occurred.

### [Scratch Resistance]

A solid image having a size of 4 cm by 5 cm (ink load: 0.5 mg/cm²) was formed on printing paper (“C² (registered Japanese trademark)”, product of Fuji Xerox Co., Ltd.) using the evaluation apparatus. The formed solid image was left to stand for 30 minutes under environmental conditions of a temperature of 25° C. and a relative humidity of 50%. Next, a weight (mass 1 kg) was prepared that had a rectangular parallelepiped shape with a rectangular bottom surface having a size of 4 cm by 5 cm. Non-used printing paper (“C² (registered Japanese trademark)”, product of Fuji Xerox Co., Ltd.) was attached to the bottom surface of the weight. In the following, the non-used printing paper may be also referred to below as evaluation paper. Subsequently, an initial image density (OD_{A}) of the evaluation paper was measured using a fluorescence spectrodensitometer (“FD-5”, product of KONICA MINOLTA JAPAN, INC.). Next, the aforementioned weight was put on the printing paper with the solid image formed thereon. Subsequently, the weight was moved on the solid image back and forth five times horizontally. In this manner, friction was caused between the evaluation paper and the solid image by 5-time reciprocating motion of a load of 1 kg. Next, a post-test image density (OD_{B}) of a surface on a side of the evaluation paper that had been subjected to the friction with the solid image was measured using the aforementioned fluorescence spectrodensitometer. Then, “OD_{B}−OD_{A}” was calculated and the calculated value ΔOD was taken to be an evaluation value of the image for evaluation of scratch resistance. A lower value of ΔOD indicates more excellent scratch resistance of an image. Scratch resistance of each image was evaluated as good if ΔOD was no greater than 0.010 and evaluated as poor if ΔOD is greater than 0.010.

In Table 4, “CB”, “OPE”, and “CW” represent carbon black, oxidized polyethylene wax, and carnauba wax, respectively.

TABLE 4

| | Ink | | | | | | | | | | | | | | |
|---|---|---|---|---|---|---|---|---|---|---|---|---|---|---|---|
| | Pigment particle | | | Binder resin particle | | | | | | | | | | | |
| | dispersion | | | dispersion | | | Wax particle dispersion | | | | | | | Evaluation | |
| | | | D_{P} | | D_{B} | AV_{B} | | | D_{W} | AV_{W} | | | | | Ejection |
| | Type | Pigment | [nm] | Type | [nm] | [mgKOH/g] | Type | Wax | [nm] | [mgKOH/g] | D_{W}/D_{P} | D_{W}/D_{B} | ΔAV | ΔOD | stability |
| Example 1 | A | CB | 100 | A | 100 | 10 | A | OPE | 150 | 20 | 1.50 | 1.50 | 10 | 0.008 | A |
| Example 2 | A | CB | 100 | B | 100 | 30 | A | OPE | 150 | 20 | 1.50 | 1.50 | 10 | 0.007 | A |
| Example 3 | C | CB | 80 | E | 80 | 10 | C | OPE | 120 | 20 | 1.50 | 1.50 | 10 | 0.007 | A |
| Example 4 | A | CB | 100 | A | 100 | 10 | D | OPE | 380 | 20 | 3.80 | 3.80 | 10 | 0.005 | A |
| Example 5 | B | Cyan | 90 | A | 100 | 10 | A | OPE | 150 | 20 | 1.67 | 1.50 | 10 | 0.008 | A |
| Example 6 | A | CB | 100 | A | 100 | 10 | E | CW | 150 | 12 | 1.50 | 1.50 | 2 | 0.008 | A |
| Comparative | A | CB | 100 | A | 100 | 10 | — | — | — | — | — | — | — | 0.030 | A |
| Example 1 | | | | | | | | | | | | | | | |
| Comparative | A | CB | 100 | C | 100 | 8 | A | OPE | 150 | 20 | 1.50 | 1.50 | 12 | 0.018 | A |
| Example 2 | | | | | | | | | | | | | | | |
| Comparative | A | CB | 100 | D | 100 | 32 | A | OPE | 150 | 20 | 1.50 | 1.50 | 12 | 0.020 | A |
| Example 3 | | | | | | | | | | | | | | | |
| Comparative | A | CB | 100 | A | 100 | 10 | B | OPE | 140 | 20 | 1.40 | 1.40 | 10 | 0.015 | A |
| Example 4 | | | | | | | | | | | | | | | |
| Comparative | A | CB | 100 | A | 100 | 10 | F | OPE | 500 | 20 | 5.00 | 5.00 | 10 | 0.005 | B |
| Example 5 | | | | | | | | | | | | | | | |

Each of the inks of Examples 1 to 6 contained pigment particles containing a pigment, binder resin particles containing a binder resin, and wax particles containing a wax. A ratio (D_{W}/D_{B}) of a volume median diameter D_{W} of the wax particles to a volume median diameter D_{B} of the binder resin particles was at least 1.45. A ratio (D_{W}/D_{P}) of the volume median diameter D_{W} of the wax particles to a volume median diameter D_{P} of the pigment particles was at least 1.45. The volume median diameter D_{W} of the wax particles is no greater than 400 nm. An absolute value of a difference ΔAV between an acid value AV_{B} of the binder resin particles and an acid value AV_{W} of the wax particles was no greater than 11 mgKOH/g. Each of the inks of Examples 1 to 6 was excellent in ejection stability and an image excellent in scratch resistance was formed with the use of any of the inks of Examples 1 to 6.

By contrast, each of the inks of Comparative Examples 1 to 5 did not have the above features, and was therefore evaluated as poor in either or both ejection stability and scratch resistance of a formed image.

Specifically, the ink of Comparative Example 1 contained no wax particles. As a result, the ink of Comparative Example 1 was evaluated as poor in scratch resistances of a formed image.

The inks of Comparative Examples 2 and 3 each had an absolute value of a difference ΔAV between an acid value AV_{B} of binder resin particles and an acid value AV_{W} of wax particles of greater than 11 mgKOH/g. As a result, the inks of Comparative Examples 2 and 3 were each evaluated as poor in scratch resistances of a formed image. The wax particles of each of the inks of Comparative Examples 2 and 3, which had a large absolute value of a difference ΔAV, tended to agglomerate together. Accordingly, it was determined that the wax particles of each of the inks of Comparative Examples 2 and 3 had been non-uniformly dispersed in a formed image with a result that the wax particles insufficiently functioned as spacers.

The ratio D_{W}/D_{P} and the ratio D_{W}/D_{B} of the ink of Comparative Example 4 were less than 1.45. As a result, the ink of Comparative Example 4 was evaluated as poor in scratch resistance of a formed image. Wax particles were not so large relative to pigment particles and binder resin particles in the ink of Comparative Example 4. Accordingly, it was determined that the wax particles insufficiently functioned as spacers.

Wax particles of the ink of Comparative Example 5 had a volume median diameter D_{W} of greater than 400 nm. As a result, the ink of Comparative Example 5 was evaluated as poor in ejection stability. It was determined that excessively large wax particles of the ink of Comparative Example 5 had accordingly caused nozzle clogging.

What is claimed is:

1. An inkjet ink comprising:
pigment particles containing a pigment;
binder resin particles containing a binder resin; and
wax particles containing a wax, wherein
a ratio (D_{W}/D_{B}) of a volume median diameter D_{W} of the wax particles to a volume median diameter D_{B} of the binder resin particles is at least 1.45,
a ratio (D_{W}/D_{P}) of the volume median diameter D_{W} of the wax particles to a volume median diameter D_{P} of the pigment particles is at least 1.45,
the volume median diameter D_{W} of the wax particles is no greater than 400 nm, and
an absolute value of a difference ΔAV between an acid value AV_{B} of the binder resin particles and an acid value AV_{W} of the wax particles is no greater than 11 mgKOH/g.

2. The inkjet ink according to claim 1, wherein
the volume median diameter D_{P} of the pigment particles is at least 50 nm and no greater than 150 nm,
the volume median diameter D_{B} of the binder resin particles is at least 50 nm and no greater than 150 nm, and
the volume median diameter D_{W} of the wax particles is at least 100 nm and no greater than 400 nm.

3. The inkjet ink according to claim 1, wherein
the acid value AV_{B} of the binder resin particles is at least 9 mgKOH/g and no greater than 31 mgKOH/g, and
the acid value AV_{W} of the wax particles is at least 15 mgKOH/g and no greater than 25 mgKOH/g.

4. The inkjet ink according to claim 1, wherein
a percentage content of the binder resin particles is at least 0.5% by mass and no greater than 10.0% by mass.

5. The inkjet ink according to claim 1, wherein
a percentage content of the wax particles is at least 0.1% by mass and no greater than 3.0% by mass.
